(19) United States
(12) Patent Application Publication
(10) Pub. No.: US 2010/0266324 A1
(43) Pub. Date: Oct. 21, 2010

(54) IMAGE RECORDING DEVICE AND ITS FEED STOPPAGE METHOD

(75) Inventor: Masaaki SHIBUYA, Tokyo (JP)

Correspondence Address: FRISHAUF, HOLTZ, GOODMAN & CHICK, P.C., 16th Floor, 220 Fifth Avenue, NEW YORK, NY, 10017-2023, US

(73) Assignee: Olympus Corporation, Tokyo (JP)

(21) Appl. No.: 12/760,656

(22) Filed: Apr. 15, 2010

(30) Foreign Application Priority Data
Apr. 21, 2009 (JP) 2009-102618

(51) Int. Cl. B41J 11/42; B41J 11/66

(52) U.S. Cl. 400/582; 400/621

(57) ABSTRACT

This image recording device records images on a continuous recording medium conveyed by a conveyance unit and cuts the recording medium on which images are recorded to a predetermined size using a cutting roller which rotates in synchronization with a conveyance velocity of the recording medium. Then, when the conveyance unit is stopped, the image recording device detects the position of a cutting blade provided on the cutting roller and controls a stoppage timing for stopping the conveyance unit, using this detection timing as a starting point.

### CROSS REFERENCE TO RELATED APPLICATION

This application is based upon and claims the benefit of priority from prior Japanese Application No. 2009-102618, filed Apr. 21, 2009, the entire contents of which are incorporated herein by reference.

### BACKGROUND OF THE INVENTION

1. Field of the Invention

The present invention relates to an image recording device for recording images on a recording medium such as a roll of paper or the like and cutting the recorded medium to a predetermined size, and to a feed stoppage method thereof.

2. Description of Related Art

Conventionally, an ink-jet image recording device for jetting ink and recording images on a recording medium and an electro-photographic image recording device for recording images on a recording medium using toner are known.

Such image recording devices include an image recording device provided with a cutting mechanism, for recording images on a continuous recording medium such as a continuous roll of paper and cutting rolled paper on which an image is recorded to a predetermined size.

For example, Japanese Patent No. 3550719 discloses a printer with a rotary cutter built in. The printer of Japanese Patent No. 3550719 cuts continuous form paper without stopping the feed of the continuous form paper.

More specifically, a drive of the rotary cut is controlled on the basis of the timing (position) when a cut mark printed in advance on continuous form paper is detected. In other words, paper feed and cutter drive are independently controlled.

### SUMMARY OF THE INVENTION

The image recording device of the present invention comprises a continuous recording medium; a conveyance unit for conveying the recording medium; a convey information generation unit for generating a signal corresponding to the conveying of the recording medium; an image recording unit which is controlled on the basis of the signal generated by the convey information generation unit, for recording an image on the recording medium; a cutting unit which comprises a rotator and a cutting blade provided on the rotator, for rotating the rotator in synchronization with a conveyance velocity of the recording medium and cutting the recording medium to a predetermined size; a position detection unit for detecting a position of the cutting blade; and a control unit for at least controlling stoppage of the conveyance unit. The control unit comprises a cutting control unit for starting to count the number of the signals generated by the convey information generation unit from a starting point at which a detection signal is detected by the position detection unit, notifying the conveyance unit of a stoppage signal when the number of the counted signals has reached a predetermined number, and reducing the conveyance velocity of the conveyance unit.

The feed stoppage method of the present invention is used for an image recording device for recording images on a continuous recording medium fed by the conveyance unit and cutting the recording medium on which an image is recorded to a predetermined size using a cutting roller with a cutting blade which rotates in synchronization with the conveyance velocity of the recording medium. The feed stoppage method detects cutting timing for cutting the recording medium using the cutting roller, feeds the recording medium a predetermined feed amount, using the cutting timing as a starting point, and reduces the conveyance velocity of the conveyance unit.

### BRIEF DESCRIPTION OF DRAWINGS

FIG. 1 is a block diagram illustrating the control system configuration of the image recording device according to the preferred embodiment of the present invention.

FIG. 2 schematically illustrates the arrangement of respective units, excluding the control unit, of the image recording device according to the preferred embodiment of the present invention.

FIG. 3 is a perspective view illustrating the structure of the cutting unit of the image recording device according to the preferred embodiment of the present invention.

FIG. 4 is a block diagram illustrating the system configuration of the cutting control unit and its surroundings in the image recording device according to the preferred embodiment of the present invention.

FIG. 5 is a timing chart illustrating the stoppage timing of a conveyance motor at the ending time of the image record of the image recording device according to the preferred embodiment of the present invention.

### DESCRIPTION OF THE PREFERRED EMBODIMENTS

The preferred embodiment of the present invention will be explained below with reference to the drawings.

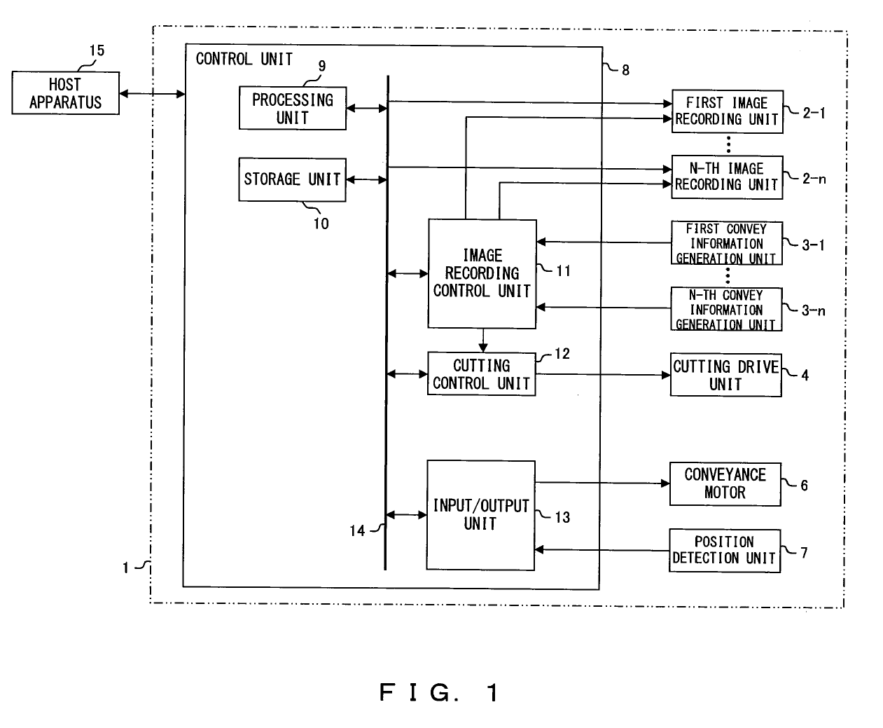

FIG. 1 is a block diagram illustrating the control system configuration of an image recording device according to the preferred embodiment of the present invention.

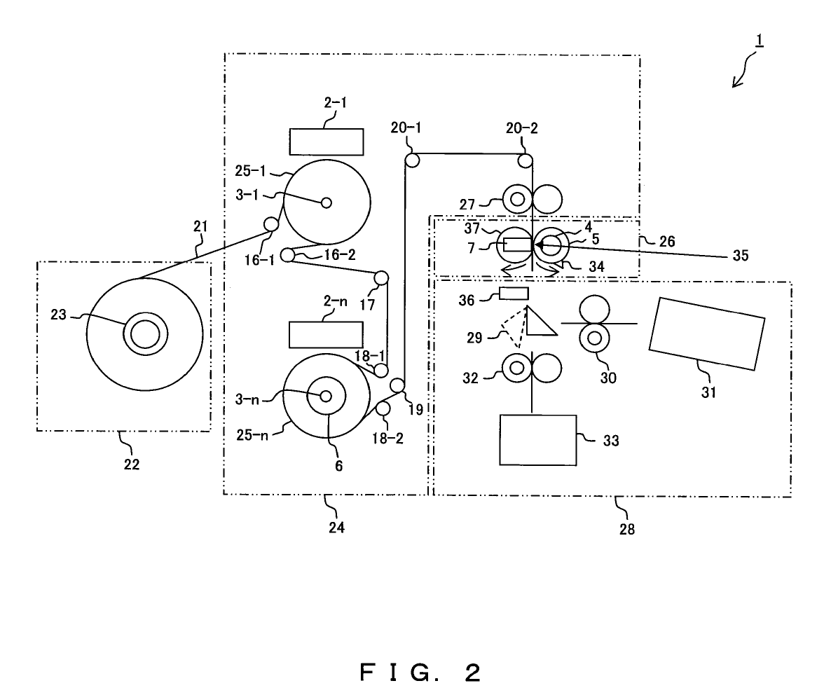

FIG. 2 schematically illustrates the arrangement of respective units, excluding the control unit, of an image recording device according to the preferred embodiment of the present invention. An image recording device according to the preferred embodiment of the present invention will be explained below with reference to FIGS. 1 and 2.

Firstly, as illustrated in FIG. 2, an image recording device (image recording apparatus) 1 comprises a supply unit 22, an image recording unit 24, a cutting unit 26, and a discharge unit 28.

Firstly, the supply unit 22 will be explained.

The supply unit 22 holds a recording medium 21 in a rotatable state. Then, the supply unit 22 rolls out the recording medium 21 to the image recording unit 24. In this preferred embodiment, for the recording medium 21, a continuous medium such as a roll of paper, a continuous film or the like is used.

This supply unit 22 is provided with a brake 23 for giving backward tension to the recording medium 21 in the opposite direction of the convey direction. This brake 23 controls the backward tension on the basis of the remaining amount of the recording medium 21. The supply unit 22 is provided with a sensor for detecting the remaining amount of the recording medium 21, which is not illustrated.

Next, the image recording unit 24 will be explained.

In order to convey the recording medium 21 supplied from the supply unit 22, the image recording unit 24 comprises a conveyance unit includes a plurality of rollers (16-1, 16-2, 17, 18-1, 18-2, 19, 20-1 and 20-2), a first medium holder 25-1 through an n-th medium holder 25-n, a first convey information generation unit (a first feed information unit) 3-1 through an n-th convey information generation unit (a second feed information unit) 3-n, a conveyance motor (a medium feed motor) 6 as a driving unit, and a pair of nip rollers 27.

The image recording unit 24 comprises a first image recording unit 2-1 through an n-th image recording unit 2-n are arranged opposed to the first medium holder 25-1 through the n-th medium holder 25-n in order to record images on the recording medium 21 supplied from the supply unit 22.

The image recording unit 24 in this preferred embodiment is provided with two each of recording units, convey information generation units, and medium holders so as to record images on both surfaces of the recording medium 21.

Therefore, after this, the n-th image recording unit 2-n, the n-th medium holder 25-n and the n-th convey information generation unit 3-n are called the second image recording unit 2-2, the second medium holder 25-2, and the second convey information generation unit 3-2, respectively.

The respective numbers of image recording units, medium holders and convey information generation units are not limited to these and can be set according to conditions for image recording.

The recording medium 21 supplied from the supply unit 22 is wound around the first medium holder 25-1 at a winding angle of 330 degrees by free rollers 16-1 and 16-2.

Then, the recording medium 21 is closely held to the first medium holder 25-1 by the wind-starting backward tension and wind-ending tension to the first medium holder 25-1. Thus, the recording medium can be conveyed on the first medium holder 25-1 without sliding.

In this preferred embodiment, the first medium holder 25-1 becomes a driven drum rotated by the second medium holder 25-2 via the recording medium 21. In other words, the medium holder 25-1 is not provided with a motor for rotating the medium holder 25-1 itself.

To the first surface of the recording medium 21 wound around the first medium holder 25-1, images are recorded by the first image recording unit 2-1.

More specifically, the first image recording unit 2-1 is provided with recording heads (line heads), which are not illustrated, for jetting, for example, a total of four colors of ink, cyan (C), black (K), magenta (M) and yellow (Y).

These recording heads (line heads) have a width greater than the width of the recording medium 21. The first image recording unit 2-1 jets ink from the nozzles of respective recording heads onto the recording medium 21 conveyed by the first medium holder 25-1 and records images.

Each recording head of the first image recording unit 2-1 in this preferred embodiment records images in such a way that resolution in a convey direction may become 300 dpi.

In this case, the first medium holder 25-1 is composed of, for example, an aluminum rotatable drum. The first convey information generation unit 3-1 is connected to the rotation shaft of this first medium holder 25-1.

This first convey information generation unit 3-1 outputs convey information (a signal) corresponding to the rotational position of the first medium holder 25-1 accompanying the rotation of the first medium holder 25-1. In other words, the first convey information generation unit 3-1 outputs convey information (a signal) about the amount of movement of the recording medium 21.

The output signal is input to the first image recording unit 2-1 and a cutting control unit 12 via an image recording control unit 11, as illustrated in FIG. 1. Thus, the first image recording unit 2-1 controls the drive of recording heads on the basis of the above signal.

Specifically, the first image recording unit 2-1 controls the jetting of ink to be jetted from the recording head on the basis of the above signal. The first convey information generation unit 3-1 in this preferred embodiment uses a rotary encoder that outputs a signal of 18000 pulses per rotation.

After the first medium holder 25-1 is completely wound, the recording medium 21 is wound around the second medium holder 25-2 at a winding angle of 330 degrees by free rollers 18-1 and 18-2 via free roller 17.

Thus, the recording medium 21 is closely held by the second medium holder 25-2 and is conveyed on the second medium holder 25-2 without sliding. Images are recorded on the second surface of the recording medium 21 by the second image recording unit 2-2. More specifically, the second image recording unit 2-2 has recording heads (line heads), which are not illustrated, for jetting, for example, a total of four colors of ink, cyan (C), black (K), magenta (M) and yellow (Y), like the first image recording unit 2-1.

Then, the second image recording unit 2-2 jets ink from the nozzles of respective recording heads onto the recording medium 21 conveyed by the second medium holder 25-2 and records images.

In the respective recording heads of the second image recording unit 2-2 in this preferred embodiment as well, images are recorded in such a way that resolution in the convey direction may become 300 dpi.

In this case, the second medium holder 25-2 is composed of an aluminum rotatable drum as in the first medium holder 25-1.

The second convey information generation unit 3-2 for outputting a signal of 18000 pulses per rotation is connected to a rotation shaft of this second medium holder 25-2 as in the first medium holder 25-1.

This output signal is input to the second image recording unit 2-2 and the cutting control unit 12 via the image recording control unit 11, as illustrated in FIG. 1. Thus, the second image recording unit 2-2 controls the drive of recording heads on the basis of the above signal.

Furthermore, the conveyance motor 6 as a driving unit is connected to the rotation shaft of the second medium holder 25-2.

The recording medium 21 wound around the second medium holder 25-2 is conveyed downstream by driving this conveyance motor 6. By such a structure, the second medium holder 25-2 becomes a driving drum.

As described earlier, the recording medium 21 is closely held by the first medium holder 25-1 and the second medium holder 25-2.

In other words, the recording medium 21 can be conveyed by the first medium holder 25-1 and the second medium holder 25-2 without sliding. Therefore, the first medium holder 25-1 and the second medium holder 25-2 rotate at the same velocity.

In other words, respective signals output from the first convey information generation unit 3-1 and the second convey information generation unit 3-2 become the same. Therefore, a signal input to the cutting control unit 12 can also be only one of the respective signals output by the first convey information generation unit 3-1 and the second convey information generation unit 3-2.

Furthermore, a convey information generation unit can also be connected to only one of the first medium holder 25-1 and the second medium holder 25-2.

After the second medium holder 25-2 is completely wound, the recording medium 21 is forwarded to the pair of nip rollers 27 via the free rollers 19, 20-1 and 20-2.

A driving motor, which is not illustrated, is connected to one of the pair of nip rollers 27. This pair of nip rollers 27 is controlled in such a way that the linear velocity of an outer circumference surface may coincide with a conveyance velocity of the recording medium 21.

In other words, the pair of nip rollers 27 is driven in synchronization with the conveyance velocity of the recording medium 21. Then, the pair of nip rollers 27 forwards the recording medium 21 to the cutting unit 26.

Next, the cutting unit 26 will be explained.

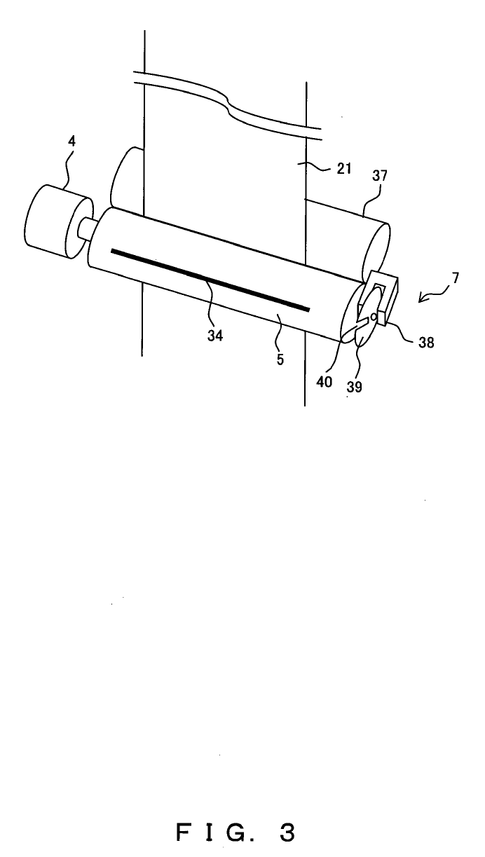

The cutting unit 26 comprises a cutting drive unit 4, a cutting roller 5 as a rotator, a position detection unit 7 and a blade-receiving roller 37, as illustrated in FIGS. 2 and 3.

FIG. 3 is a perspective view of the cutting unit 26 illustrated in FIG. 2 obtained by obliquely facing the paper surface so that the structure of a cutting blade 34 may be easily understood. Therefore, the relative arrangement relation between the cutting roller 5 and the blade-receiving roller 37 becomes the reversal of that illustrated in FIG. 2.

This cutting roller 5 is provided with a cutting blade 34. In this preferred embodiment, the cutting roller 5 is provided with one cutting blade 34 on its circumference surface.

The cutting drive unit 4 is mounted on one terminal end of this cutting roller 5. This cutting drive unit 4 comprises a servo-motor as a motor and is controlled by the cutting control unit 12, as illustrated in FIG. 1.

Specifically, the cutting control unit 12 controls the drive of the cutting drive unit 4 in such a way that the linear velocity on the outer circumference surface of the cutting roller 5 may coincide with the conveyance velocity of the recording medium 21 being conveyed, on the basis of a signal from the image recording control unit 11, as illustrated in FIG. 1.

In other words, the cutting drive unit 4 rotates the cutting roller 5 in synchronization with the conveyance velocity of the recording medium 21. The motor provided for the cutting drive unit 4 is not limited to a servo-motor and can also be composed of a stepping motor or the like.

The cutting roller 5 rotates in the direction of the arrow illustrated in FIG. 2 (counter-clock wise direction) by the drive of the cutting drive unit 4. The blade receiving roller 37 rotates in the direction of the arrow illustrated in FIG. 2 (clockwise direction) via a belt and a gear, accompanying the rotation of the cutting roller 5.

Thus, the cutting blade 34 comes to face the blade receiving roller 37 by the rotation of the cutting roller 5 and the blade receiving roller 37. Then, the recording medium 21 is cut in a position where the cutting blade 34 faces the blade receiving roller 37 (cutting position 35).

In this preferred embodiment, for the recording medium 21, for example, a roll of paper 297 mm wide is used and the circumference of the cutting roller is 420 mm. Thus, the cutting roller 5 driven by the cutting driving unit 4 cuts the recording medium 21 to an A3 size (420 mm*297 mm).

The position detection unit 7 detects the position of the cutting blade 34. In this preferred embodiment, the position detection unit 7 detects the cutting position 35 in which the cutting blade 34 cuts the recording medium 21. Then, the position detection unit 7 notifies a processing unit 9 illustrated in FIG. 1 of a detection signal.

In this preferred embodiment, this position detection unit 7 is provided, for example, at the other terminal end of the cutting roller 5, as illustrated in FIG. 3.

The position detection unit 7 comprises a circular disc 39 and a cutting origin sensor 38, as illustrated in FIG. 3. The circular disc 39 and the cutting origin sensor 38 are provided at one terminal end of the cutting roller 5, as illustrated in FIG. 3.

The circular disc 39 rotates in synchronization with the rotation of the cutting roller 5. A slit 40 is formed at one location on the circumference portion of the circular disc 39.

This slit 40 is formed in such a way that its position may coincide with the position of the cutting blade 34. In other words, the slit 40 is formed in such a way that a position in which the slit 40 is detected may become the position of the cutting blade 34.

The cutting origin sensor 38 is disposed in such a way as to pinch the circular disc 39. For this cutting origin sensor 38, a light-transmitting sensor is used.

Then, the cutting origin sensor 38 detects the position of the cutting blade 34 by detecting the position of the slit 40.

In other words, the cutting origin sensor 38 is disposed in such a way that the cutting blade 34 may detect the slit 40 in the cutting position 35.

Next, the discharge unit 28 will be explained.

The discharge unit 28 comprises a paper-jam detection sensor 36, a discharge-route switching unit 29, a pair of rollers 30, a first paper receiving tray 31, a pair of rollers 32, and a second paper receiving tray 33.

The paper-jam detection sensor 36 detects paper jams caused by the cut recording medium 21. When the detection sensor 36 cannot confirm the passage of the cut recording medium 21 within a specified time, the control unit 8 determines that a paper jam has occurred and brings the image recording device to an emergency stop.

The control unit 8 also checks whether any remaining cut recording medium 21 is left after the completion of the image recording operation, by monitoring the paper-jam detection sensor 36.

The discharge-route switching unit 29 switches the discharge route of the recording medium 21 cut by the cutting unit 26 between the first paper receiving tray 31 and the second paper receiving tray 33.

In other words, the discharge-route switching unit 29 guides unnecessary media and the recording medium 21 on which an image is recorded to the second paper receiving tray 33 and the first paper receiving tray 31, respectively.

In order to smoothly discharge the cut recording medium 21, the pair of rollers 30 is disposed on the route to the first paper receiving tray 31 and the pair of rollers 32 is disposed on the route to the second paper receiving tray 33.

Next, the control unit 8 of this image recording device 1, illustrated in FIG. 1, will be explained.

As illustrated in FIG. 1, the control unit 8 comprises the processing unit 9, a storage unit 10, the image recording control unit 11, the cutting control unit 12, and an input/output unit 13.

The storage unit 10, the image recording control unit 11, the cutting control unit 12, and the input/output unit 13 are connected to the processing unit 9 via a bus 14.

The first image recording unit 2-1 and second image recording unit 2-2 are also connected to the processing unit 9 via the bus 14. A host apparatus 15 is connected to the control unit 8.

The processing unit 9 is a central processing unit for controlling the image recording device 1 and performs computation according to a processing program. The processing unit 9 outputs instructions to the above respective units on the basis of the computation result and controls the entire image recording device 1.

The storage unit 10 stores the operation program of the image recording device 1. The storage unit 10 temporarily stores recording data from the host apparatus 15. The storage unit 10 also stores various adjustment parameters and the like of the image recording device 1.

The image recording control unit 11 optimizes signals output from the first convey information generation unit 3-1 and the second convey information generation unit 3-2 and outputs them to the first image recording unit 2-1, the second image recording unit 2-2, and the cutting control unit 12.

The cutting control unit 12 optimizes signals output from the first convey information generation unit 3-1 and the second convey information generation unit 3-2 and outputs them to the cutting drive unit 4. Then, the cutting drive unit 4 drives and rotates the cutting roller 5 according to the signals input from the cutting control unit 12.

The input/output unit 13 drives a conveyance motor 6 according to instructions from the processing unit 9. The input/output unit 13 notifies the processing unit 9 of the signal detected by the position detection unit 7.

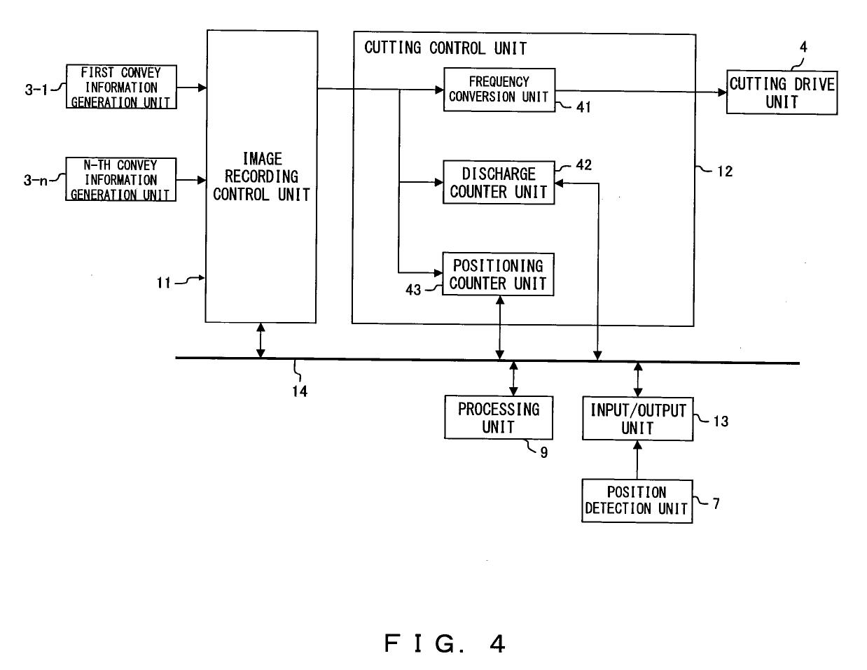

FIG. 4 is a block diagram illustrating the system configuration including the cutting control unit 12 and its surroundings. The cutting control unit 12 comprises a frequency conversion unit 41, a discharge counter unit (a first count unit) 42, and a positioning counter unit (a second count unit) 43.

The frequency conversion unit 41 converts signals from the convey information generation unit to generate signals optimal to the cutting drive unit 4. Then, the frequency conversion unit 41 outputs the generated signals to the cutting drive unit 4.

The discharge counter unit 42 counts the number of signals output from the convey information generation unit until the recording medium 21 reaches from the recording position of the image recording unit to the cutting position 35.

The control unit 8 checks whether the position to be cut of the recording medium 21 on which an image is recorded has reached the cutting position 35 of the cutting roller 5 on the basis of the number of signals counted by the discharge counter 42.

The positioning counter unit 43 determines the stoppage timing of the recording medium 21 after the recording process is completed.

Next, a method for synchronizing the cutting roller 5 with the conveyance velocity of the recording medium 21 will be explained.

In order to synchronize the rotation velocity of the cutting roller 5 with the conveyance velocity of the recording medium 21, it is necessary to obtain the velocity information of the recording medium 21.

In this preferred embodiment, the output pulse of the first convey information generation unit 3-1 in the first image recording unit 2-1 is set to be output at 300 dpi, as described earlier.

Therefore, the driving pulse of the cutting roller 5 can be obtained by converting the output pulse of the first convey information generation unit 3-1.

The outer circumference of the cutting roller 5 is 420 mm, as described earlier. Therefore, the outer circumference of the cutting roller 5 is converted to the number of pulses of the first convey information generation unit 3-1 as follows.

420*(300/25.4)≈4960 pulses

Therefore, the cutting control unit 12 is designed in such a way that the cutting roller 5 makes a full rotation in 4960 pulses. This function is realized by the frequency conversion unit 41.

For example, when a motor that makes a full rotation in 8000 pulses is used for the cutting drive unit 4, the frequency conversion unit 41 is designed in such a way as to output 8000 pulses when 4960 pulses are input.

Although this frequency conversion unit 41 can be realized by a PLL (phase-locked loop) or the like, this technique is known. Therefore, a detailed description of it is omitted.

The conveyance velocity of the recording medium 21 and the linear velocity of the cutting roller 5 are synchronized by the method explained above. As a result, the cutting roller 5 rotates accompanying the conveyance of recording medium 21.

At the starting time of recording, the control unit 8 controls the timing of image recording using as the starting point the timing at which the position detection unit 7 (cutting origin sensor 38) detects the cutting blade 34, by taking into consideration a convey route (feed route) length from the recording position up to the cutting position 35, the cutting size of the recording medium 21, and the like.

In other words, if the convey route length from the recording position up to the cutting position 35 is an integral multiple of the cutting size (length in the convey direction of a cut recording medium), the control unit 8 starts image recording using, as the starting point, the timing at which the position detection unit 7 (cutting origin sensor 38) detects the cutting blade 34.

If the convey route length from the recording position up to the cutting position 35 is not an integral multiple of the cutting size, the control unit 8 starts image recording after delaying the timing in such a way as to make the convey route length from the recording position up to the cutting position 35 an integral multiple of the cutting size.

Thus, the cutting roller 5 can cut the recording medium 21 in a desired position without the use of a cut mark or the like.

Next, the stoppage timing of the conveyance motor 6 at the completion time of image recording, which is a feature of this preferred embodiment, will be explained.

In this preferred embodiment, respective signals output from the first convey information generation unit 3-1 and the second convey information generation unit 3-2 become the same. Therefore, a description will be made assuming that a signal output by the first convey information generation unit 3-1 is input to the cutting control unit 12.

The convey route length from the recording position of the first image recording unit 2-1 up to the cutting position 35 of the cutting roller 5 is determined by a design value. Therefore, the convey route length can be converted to the number of pulses output from the first convey information generation unit 3-1 in advance. This converted number of pulses is stored in the storage unit 10.

After the recording of the last image is completed, the control unit 8 (discharge counter unit 42) counts the number of pulses output from the first convey information generation unit 3-1, up to the number corresponding to the convey route length. By doing so, the control unit 8 obtains the information that the position to be cut of the last image has reached the cutting position 35 of the cutting roller 5.

Then, the timing of the position detection unit 7 (cutting origin sensor 38) detecting the cutting blade 34 in the last image indicates the fact that the last image has been cut. This timing becomes a base for stopping the convey (feed) of the recording medium 21.

Here, the above timing, that is, the stoppage of conveying (feeding) of the recording medium 21 at the moment the last image is cut by the cutting blade 34, is considered.

When the normal conveyance velocity and brake acceleration at the time of stoppage of the conveyance motor 6 are 500 mm/sec and 200 mm/seĉ2, respectively, the recording medium 21 stops 2.5 seconds after the conveyance motor 6 is instructed to stop. In other words, the recording medium 21 advances 625 mm.

Since the circumference of the cutting roller 5 is 420 mm, at this moment the cutting blade 34 rotates by the following angle.

(625/420)*360(°)≈536°

In other words, the cutting blade 34 stops in a position obtained by rotating the cutting blade 34 from the cutting position 35 by 176 degrees.

Since the rotation cycle (linear velocity) of the cutting roller 5 is synchronized with the conveyance velocity of the recording medium 21, the leading end of the cut recording medium 21 stops in a position advanced from the cutting position 35 by the following distance.

625 mm−420 mm=205 mm

Thus, if the conveying (feeding) of the recording medium is controlled to stop at the timing of the position detecting unit 7 (cutting origin sensor 38) detecting the cutting blade 34 when the cutting roller 5 rotates in synchronization with the conveyance velocity of the recording medium 21, the recording medium 21 and the cutting blade 34 are forced to be stopped only in a certain determined position.

For example, a case where the paper jam detection sensor 36 is provided as in the image recording device of this preferred embodiment is considered. If the leading end of the recording medium 21 stops in a position 205 mm away from the cutting position 35 when the paper jam detection sensor 36 is located in a position 100 mm away from the cutting position 35, the leading end of the recording medium 21 blocks the detection optical path of the paper jam detection sensor 36. Therefore, the control unit 8 determines that it is a paper jam.

Therefore, in this preferred embodiment, the stoppage positions of the recording medium 21 and the cutting blade 34 are controlled so as to be in arbitrary positions.

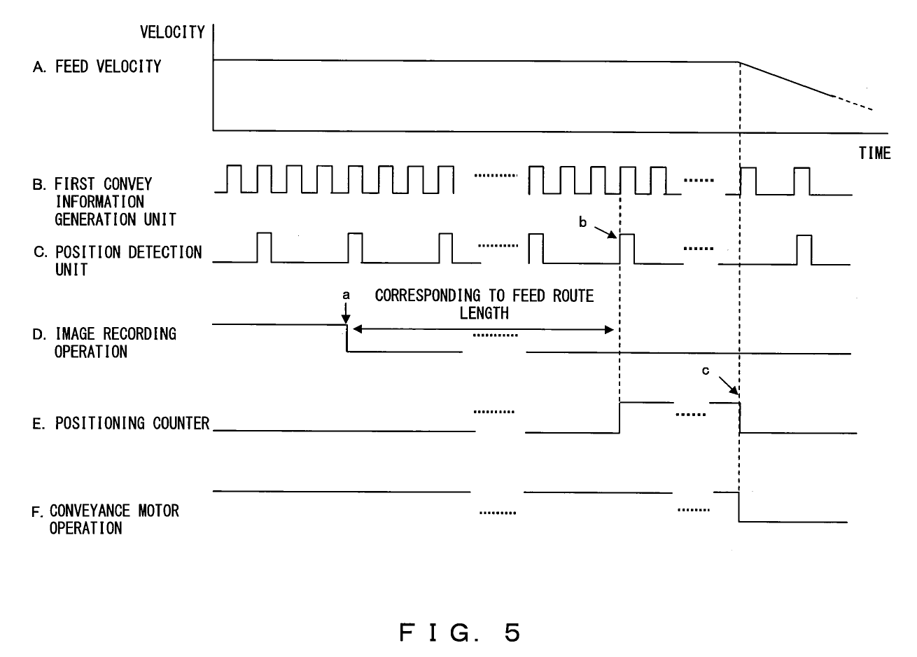

FIG. 5 is a timing chart illustrating the stoppage timing of the conveyance motor 6 at the completion time of the image recording of an image recording device 1. “A” is a timing chart illustrating the conveyance velocity of the recording medium 21.

“B” is a timing chart illustrating a signal (a pulse) output from the first convey information generation unit 3-1. “C” is a timing chart illustrating a signal output from the position detection unit 7 (cutting origin sensor 38).

“D” is a timing chart illustrating an image recording operation. “E” is a timing chart illustrating the operation of the positioning counter. “F” is a timing chart illustrating the operation of the conveyance motor.

In the following description, a method for controlling in such a way that the cutting blade 34 may stop in a position obtained by rotating the cutting blade 34 from the cutting position 35 by 60 degrees will be explained below. Furthermore, in the following description, it is assumed that the normal conveyance velocity and the brake acceleration of the conveyance motor 6 at the time of stoppage are 500 mm/sec and 200 mm/seĉ2, respectively.

As illustrated in A of FIG. 5, the recording medium 21 is conveyed in a constant conveyance velocity (500 mm/sec in this preferred embodiment) by the conveyance motor 6 until it is instructed to stop, which will be described later.

Therefore, the first convey information generation unit 3-1 outputs signals at certain predetermined intervals, as illustrated in B of FIG. 5. The cutting roller 5 is controlled by the cutting control unit 12 in such a way as to be synchronized with the conveyance velocity of the recording medium 21.

Therefore, the position detection unit 7 (cutting origin sensor 38) outputs signals at certain predetermined intervals on the basis of the signal output from the first convey information generation unit 3-1, as illustrated in C of FIG. 5.

Images are recorded on the recording medium 21 in such a state.

Then, as illustrated in D of FIG. 5, when the last image of image information reported from the host apparatus 15 is recorded, the discharge counter unit 42 counts the number of pulses corresponding to the convey route (feed route) length on the basis of the first convey information generation unit 3-1.

In addition, a position “a” in D of FIG. 5 indicates the timing at which the first image recording unit 2-1 completes the recording of the last image.

After the discharge counter unit 42 completes the counting of the number of pulses corresponding to the convey route length, the position detection unit 7 detects the cutting blade 34 at this completed timing (position “b” in C of FIG. 5).

As a result, the last image recorded on the recording medium 21 is cut. In addition, the number of pulses output from the first convey information generation unit 3-1 from the position “a” to the position “b” is stored in the storage unit 10 in advance.

Thus, when the cutting blade 34 is stopped in a position obtained by rotating the cutting blade 34 from the cutting position 35 by 60 degrees, the leading end position of the cut recording medium 21 is the following distance away from the cutting position 35.

420 mm*(60/360)=70 mm

Therefore, when it is desired that the cutting blade 34 stops in a position apart from the cutting position 35 by 60 degrees, it is necessary to further rotate the cutting roller 5 from the above-explained stoppage position of 176 degrees by the following angle.

360(°)−176(°)+60(°)=244°

The number of pulses of the first convey information generation unit 3-1, corresponding to a rotation angle of 244 degrees, becomes as follows.

(244/360)*420*(300/25.4)≈3362 pulses

Therefore, the control unit 8 simply has to delay the issuance of the instruction of convey stoppage (feed stoppage) to the conveyance motor 6 for 3362 pulses. Specifically, as illustrated in E of FIG. 5, the positioning counter unit 43 starts counting the number of pulses output from the first convey information generation unit 3-1 at the point of the position “b”.

Then, the positioning counter unit 43 notifies the conveyance motor 6 of a stoppage instruction at the timing (position “c” in E of FIG. 5) at which the number of pulses reaches 3366 after the start of the count of the pulses, as illustrated in F of FIG. 5.

In addition, while the positioning counter unit 43 is counting, the conveyance motor 6 is driven at a constant velocity.

Then, as illustrated in A of FIG. 5, the conveyance velocity of the recording medium 21 is reduced from the timing of the position “c” (the brake acceleration of 200 mm/seĉ2 in this preferred embodiment) and finally is stopped in a position where the cutting blade 43 has rotated from the cutting position 35 by 60 degrees.

Thus, the control unit 8 notifies the conveyance motor 6 of a stoppage instruction after delaying for a predetermined amount of delay using the timing at which the position detection unit 7 (cutting origin sensor 38) detects the cutting blade 34 as the starting point, instead of notifying the conveyance motor 6 of a stoppage instruction using the timing at which the position detection unit 7 (cutting origin sensor 38) detects the cutting blade 34 as the starting point, and continues to gradually reduce the conveyance velocity of the recording medium 21.

Then, the cutting roller 5 can be stopped in a desired position by changing the amount of delay set in the positioning counter unit 43. The amount of delay set in the positioning counter unit 43 can also be stored in the storage unit in advance.

As explained above, according to this preferred embodiment, the continuous recording medium after image recording can be continuously cut to a predetermined size by controlling the conveying of the recording medium 21 according to the detection information of the position detection unit 7.

After the completion of recording, the cutting blade 34 can be easily stopped in a desired position (away from the cutting position 35) without the need for complex control and with a simple structure.

What is claimed is:

1. An image recording device, comprising:
a continuous recording medium;
a conveyance unit for conveying the recording medium;
a convey information generation unit for generating a signal corresponding to the conveying of the recording medium;
an image recording unit which is controlled on the basis of the signal generated by the convey information generation unit, for recording an image on the recording medium;
a cutting unit which comprises a rotator and a cutting blade provided on the rotator, for rotating the rotator in synchronization with a conveyance velocity of the recording medium and cutting the recording medium to a predetermined size;
a position detection unit for detecting a position of the cutting blade; and
a control unit for at least controlling stoppage of the conveyance unit, wherein
the control unit comprises a cutting control unit for starting to count the number of the signals generated by the convey information generation unit from a starting point at which a detection signal is detected by the position detection unit, notifying the conveyance unit of a stoppage signal when the number of the counted signals has reached a predetermined number, and reducing the conveyance velocity of the conveyance unit.

2. The image recording device according to claim 1, wherein
the position detection unit detects that a position of the cutting blade has reached a cutting position in which the recording medium is cut.

3. The image recording device according to claim 2, wherein
the position detection unit is provided on the rotator and comprises
a circular disc which rotates in synchronization with the rotator, on which a slit is formed in a position corresponding to a position of the cutting blade; and
a sensor for detecting a position of a slit on the circular disc.

4. The image recording device according to claim 1, wherein
the position detection unit detects that a position of the cutting blade has reached a cutting position in which the recording medium is cut and
the cutting control unit starts counting the number of the signal from a starting point which is a detection signal that detects that the position detection unit has cut a last image on the recording medium.

5. The image recording device according to claim 1, wherein
the detection signal detected by the position detection unit indicates a timing at which a last image on the recording medium is cut and the cutting control unit starts counting the number of the signals using the timing as a starting point.

6. The image recording device according to claim 1, wherein
the cutting control unit reduces the conveyance velocity of the conveyance unit under a certain brake acceleration.

7. The image recording device according to claim 1, wherein
the position detection unit detects that a position of the cutting blade has reached a cutting position in which the recording medium is cut and
the predetermined number is calculated on the basis of at least a rotation angle by which the rotator is rotated from the cutting position.

8. An image recording device, comprising:
a continuous recording medium;
a conveyance unit for conveying the recording medium;
a convey information generation unit for generating a pulse corresponding to the conveying of the recording medium;
an image recording unit which is controlled on the basis of the pulse generated by the convey information generation unit, for recording an image on the recording medium;
a cutting roller having a cutting blade which is controlled on the basis of the pulse generated by the convey information generation unit and rotates in synchronization with a conveyance velocity of the recording medium;
a detection unit for detecting a cutting timing at which the cutting blade cuts the recording medium; and
a control unit for at least controlling stoppage of the conveyance unit, wherein
the control unit comprises a cutting control unit for starting to count the number of the pulses generated by the convey information generation unit from the cutting timing as a starting point, notifying the conveyance unit of a stoppage signal when the number of the counted pulses has reached a predetermined number, and reducing the conveyance velocity of the conveyance unit.

9. The image recording device according to claim 8, wherein
the cutting control unit reduces the conveyance velocity of the conveyance unit under a certain brake acceleration.

10. The image recording device according to claim 8, wherein
the cutting timing is a timing at which a last image on the recording medium is cut.

11. The image recording device according to claim 8, wherein
the predetermined number is calculated at least on the basis of a rotation angle by which the cutting roller is rotated from a cutting position.

12. An image recording device, comprising:
a continuous recording medium;
a conveyance unit for conveying the recording medium;
a convey information generation unit for generating a pulse corresponding to the conveying of the recording medium;
an image recording unit which is controlled on the basis of the pulses generated by the convey information generation unit, for recording an image on the recording medium;
a cutting roller having a cutting blade which is controlled on the basis of the pulse generated by the convey information generation unit and rotates in synchronization with a conveyance velocity of the recording medium;
a detection unit for detecting a cutting timing at which the cutting blade cuts the recording medium; and
a control unit for at least controlling stoppage of the conveyance unit, wherein
the control unit comprises
a first count unit for starting to count a predetermined number of pulses corresponding to a convey route length from a recording position of the image recording unit up to a cutting position of the cutting roller from a starting point at which a last image is recorded by the image recording unit;
a second count unit for starting to count a predetermined number of pulses calculated on the basis of the stoppage position in order to stop the cutting blade at a predetermined stoppage position after the counting of the predetermined number of pulses is completed in the first count unit; and
a stoppage control unit for notifying the conveyance unit of a stoppage signal and reducing the conveyance velocity of the conveyance unit after the counting of the predetermined number of pulses is completed in the second count unit.

13. A feed stoppage method of an image recording device for recording an image on a continuous recording medium fed by a conveyance unit and cutting the recording medium on which the images are recorded to a predetermined size using a cutting roller having a cutting blade which rotates in synchronization with a conveyance velocity of the recording medium, comprising:
detecting a cutting timing at which the cutting roller cuts the recording medium; and
reducing the conveyance velocity of the conveyance unit after feeding the recording medium by a predetermined feed amount from a starting point which is the cutting timing.

14. The feed stoppage method according to claim 13, wherein
the cutting timing is a timing at which a last image on the recording medium is cut.

15. The feed stoppage method according to claim 13, wherein
the conveyance velocity of the conveyance unit is reduced under a certain brake acceleration.

16. The feed stoppage method according to claim 13, wherein
the predetermined feed amount is calculated at least on the basis of a rotation angle by which the cutting roller is rotated from a time point the cutting timing is detected.
